(19) United States
(12) Patent Application Publication
(10) Pub. No.: US 2026/0288849 A1
(43) Pub. Date: Sep. 24, 2026

(54) METHOD AND SYSTEM FOR UNDERSTANDING ENTERPRISE PROFILE, AND STORAGE MEDIUM

(71) Applicant: Qizhidao Technology Co., Ltd., Shenzhen (CN)

(72) Inventors: Xianyong JIA, Shenzhen (CN); Weiyu LIU, Shenzhen (CN); Chubin ZHENG, Shenzhen (CN); Xuzhang NING, Shenzhen (CN)

(21) Appl. No.: 19/661,797

(22) Filed: Apr. 29, 2026

Related U.S. Application Data
(63) Continuation of application No. PCT/CN2026/071338, filed on Jan. 8, 2026.

(30) Foreign Application Priority Data
Mar. 19, 2025 (CN) 202510328203.1

(51) Int. Cl. G06F 16/353; G06F 40/169; G06F 40/186; G06F 40/295

(52) U.S. Cl. CPC G06F 16/353; G06F 40/169; G06F 40/186; G06F 40/295

(57) ABSTRACT

A method for understanding enterprise profile comprises: acquiring enterprise business text data, and selecting, from a prompt template library, a corresponding prompt template; extracting features from the business text data using the prompt template to obtain initial feature data; inputting the initial feature data into a preset model to generate an initial enterprise profile of an enterprise, and modifying the preset model using the initial enterprise profile to obtain a target model; retrieving external business information items of the enterprise, calculating a correlation value between each of the plurality of external business information items and the initial enterprise profile, and inputting external business information items having correlation values greater than a preset threshold into the target model to obtain supplementary features; and inputting the initial enterprise profile and the supplementary features into the target model to generate enterprise profile tags for the enterprise.

### CROSS-REFERENCE TO RELATED APPLICATIONS

This application is a continuation of PCT/CN2026/071338, filed Jan. 08, 2026, and claims priority of Chinese Patent Application No. 202510328203.1, filed on Mar. 19, 2025. The entire contents of PCT/CN2026/071338 and Chinese Patent Application No. 202510328203.1 are incorporated herein by reference.

### TECHNICAL FIELD

The present application relates to the technical field of enterprise profiling, and in particular, to a method and system for understanding an enterprise profile, and a storage medium.

### BACKGROUND

Enterprise user profiling is an important component in enterprise informatization construction. Accurate depiction of enterprise features can provide data support for enterprise management, business decision-making, and development planning. However, enterprise business text data usually has the characteristics of diversity and complexity. How to accurately extract enterprise features from such unstructured text data and generate a high-quality enterprise profile has become a technical problem to be solved urgently in this field.

Currently, feature extraction is typically performed using a fixed pre-trained model, i.e., directly processing and analyzing the enterprise business text data using a pre-trained general model to generate an enterprise profile. Although the above method can achieve basic enterprise feature extraction, the generated enterprise profile lacks accuracy due to the lack of targeted optimization of the pre-trained model for specific enterprise features.

### SUMMARY

The present application provides a method and system for understanding an enterprise profile, and a storage medium, for improving the accuracy of a generated enterprise profile.

In a first aspect, the present application provides a method for understanding an enterprise profile, the method comprising: acquiring enterprise business text data, and selecting, from a prompt template library, a prompt template corresponding to a type of the business text data; extracting features from the business text data by using the prompt template to obtain initial feature data; inputting the initial feature data into a preset model to generate an initial enterprise profile of the enterprise, and modifying the preset model by using the initial enterprise profile to obtain a target model; retrieving a plurality of external business information items of the enterprise, calculating a correlation value between each of the plurality of external business information items and the initial enterprise profile, and inputting external business information items having correlation values greater than a preset threshold into the target model to obtain supplementary features; and inputting the initial enterprise profile and the supplementary features into the target model to generate enterprise profile tags for the enterprise.

In a second aspect, the present application provides a system for understanding an enterprise profile, the system comprising: an acquisition module, an extraction module, a first input module, a calculation module, and a second input module; wherein, the acquisition module is configured to acquire enterprise business text data, and select, from a prompt template library, a prompt template corresponding to a type of the business text data; the extraction module is configured to extract features from the business text data by using the prompt template to obtain initial feature data; the first input module is configured to input the initial feature data into a preset model to generate an initial enterprise profile of the enterprise, and modify the preset model by using the initial enterprise profile to obtain a target model; the calculation module is configured to retrieve a plurality of external business information items of the enterprise, calculate a correlation value between each of the plurality of external business information items and the initial enterprise profile, and input external business information items having correlation values greater than a preset threshold into the target model to obtain supplementary features; and the second input module is configured to input the initial enterprise profile and the supplementary features into the target model to generate enterprise profile tags for the enterprise.

In a third aspect, the present application provides an electronic device, comprising a processor, a memory, a user interface, and a network interface, wherein the memory is used for storing instructions, the user interface and the network interface are used for communicating with other devices, and the processor is used for executing the instructions stored in the memory to cause the electronic device to execute a computer program implementing the method for understanding an enterprise profile according to any one of the above.

In a fourth aspect, the present application provides a computer-readable storage medium for storing a computer program capable of being loaded and executed by a processor to implement the method for understanding an enterprise profile mentioned above.

In summary, the present application includes at least one of the following beneficial technical effects:

By selecting a prompt template corresponding to a type of business text data from the prompt template library for feature extraction, precise processing of different types of business data can be achieved; by modifying the preset model using the initial enterprise profile to obtain the target model, the pertinence of the model is improved; and combined with relevance screening of external business information and generation of supplementary features, the feature dimensions of the enterprise profile are enriched, thereby improving the accuracy of the generated enterprise profile.

### BRIEF DESCRIPTION OF THE DRAWINGS

FIG. 1 is a schematic flowchart of a method for understanding an enterprise profile provided by an embodiment of the present application;

FIG. 2 is a schematic structural diagram of a system for understanding an enterprise profile provided by an embodiment of the present application;

FIG. 3 is a schematic structural diagram of an electronic device provided by an embodiment of the present application.

List of Reference signs: 1000, electronic device; 1001, processor; 1002, communication bus; 1003, user interface; 1004, network interface; 1005, memory.

### DETAILED DESCRIPTION

In order to enable those skilled in the art to better understand the technical solutions in this specification, the technical solutions in the embodiments of this specification will be clearly and completely described below with reference to the accompanying drawings in the embodiments of this specification. Obviously, the described embodiments are only a part of the embodiments of the present application, rather than all the embodiments.

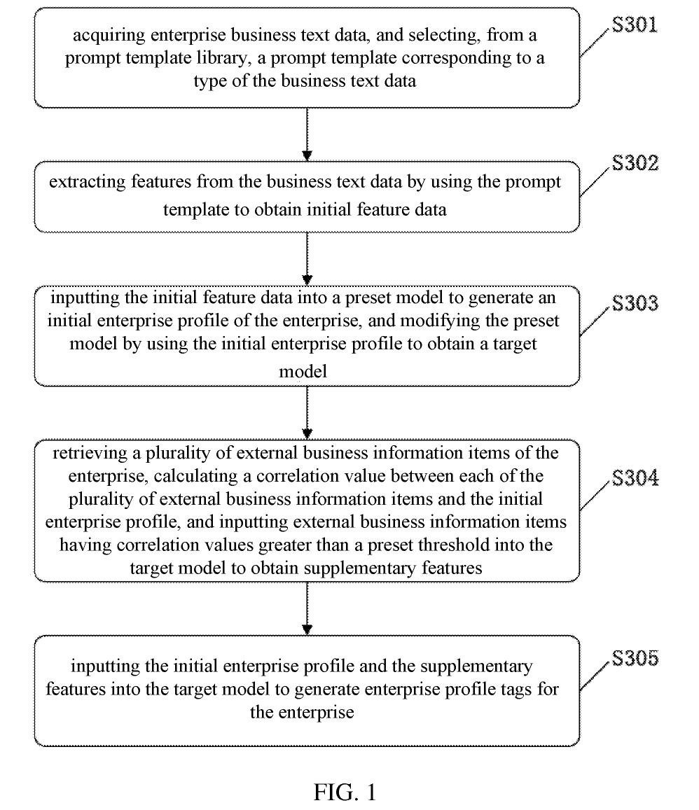

FIG. 1 is a schematic flowchart of a method for understanding an enterprise profile provided by an embodiment of the present application. As shown in FIG. 1, the method comprises S301-S305:

S301, acquiring enterprise business text data, and selecting, from a prompt template library, a prompt template corresponding to a type of the business text data.

In this embodiment, enterprise business text data is first acquired, and the enterprise business text data includes, but is not limited to, patent documents, bidding information, marketing activity data, business registration information, legal information, fiscal and taxation information, etc. of the enterprise. Since different types of business text data have different text features and data structures, for example, patent documents typically contain fixed sections such as technical field, technical background, and summary of the invention, while bidding information contains different content structures such as project description, bidding requirements, and scoring criteria, it is necessary to select corresponding processing strategies for different types of business text data.

In order to improve the accuracy and efficiency of text processing, a prompt template library is pre-established in this embodiment. The prompt template library stores prompt templates respectively corresponding to different types of business text data, and each of the prompt templates includes processing rules and extraction strategies for a specific type of business text. For example, for business text data of the patent document type, the corresponding prompt template includes extraction rules for identifying information such as technical features, inventors, and patent classifications; for business text data of the bidding information type, the corresponding prompt template includes processing rules such as project category determination, amount extraction, and technical requirement identification.

After the enterprise business text data is acquired, the system automatically identifies the type of the business text data. Specifically, the text type can be determined by analyzing format features, keyword distribution, section structure information, etc. of the text. After identifying the text type, the system selects the prompt template corresponding to the type from the prompt template library. For example, when identifying a text as a patent document, the system selects the prompt template corresponding to the patent document, which includes specific prompts and processing rules such as "Please identify the technical field, the technical problem to be solved, and the specific implementation steps of the technical solution in the text".

By using a pre-customized prompt template, key information in different types of business texts can be captured more accurately, avoiding information loss or erroneous extraction that may be caused by a general processing method. Meanwhile, the use of the prompt template also makes the processing procedure more standardized, which is conducive to maintaining the consistency of extraction results. For example, when processing a patent document of a certain technology company, by using a special patent document prompt template, key information such as the core algorithm features and technological innovation points of the company in the field of image recognition technology is successfully extracted, providing accurate basic data for subsequent enterprise profile construction.

Based on the above embodiment, as an optional implementation, in S301, before the selecting, from a prompt template library, a prompt template corresponding to a type of the business text data, the method specifically further comprises S11-S14:

S11, acquiring a business text data set of the enterprise, and classifying the business text data set to obtain a plurality of data sets.

The business text data set is a collection of various text materials generated by the enterprise during daily operations, which may contain text data in different formats and from different sources. By reasonably classifying and annotating these data, targeted prompt templates can be generated, thereby improving the accuracy of subsequent feature extraction.

After acquiring the business text data set, the system classifies the data set using a method combining rule-based and machine learning approaches. The classification process first performs a preliminary classification on the business text data set based on format features (e.g., document structure, section structure) and content features (e.g., technical terms, industry terms), and then optimizes and adjusts a result of the preliminary classification by using a pre-trained text classification model. For example, the system may classify the text data into a plurality of data sets such as a patent literature class, a research and development report class, a market analysis class, and a financial statement class. This classification manner ensures that text data of the same type can receive similar processing strategies.

S12, selecting, from a preset keyword library, keywords corresponding to text features of each of the plurality of data sets.

The preset keyword library is a dictionary containing technical terms and key expressions in various business fields, and is classified and organized according to different business fields and text types. The system selects keywords corresponding to the text features of each of the plurality of data sets from the preset keyword library. For example, for a patent literature class data set, the system selects keywords related to technical field, purpose of the invention, technical solution, etc.; for a market analysis class data set, keywords related to market size, competitive landscape, development trend, etc. are selected. These keywords will serve as the basis for subsequent text annotation.

S13, annotating each of the plurality of data sets according to the keywords to obtain multiple types of business text data.

S14, generating a prompt template corresponding to each type of business text data, storing the prompt templates in the prompt template library, and establishing a mapping relationship between each type of business text data and the corresponding prompt template.

The text annotation process is performed in a semi-automatic manner. The system first automatically annotates texts in each of the plurality of data sets by using the selected keywords, and the annotation process includes keyword matching, semantic analyzing, and context understanding. For example, when processing a technical patent document, the system annotates information such as "Technical Field: Image Recognition", "Application Scenario: Intelligent Security". In order to improve annotation quality, the system also verifies and supplements the automatic annotation results through manual review to ensure the accuracy and completeness of the annotations.

Based on the annotated business text data, the system starts generating the prompt templates. The generation process of the prompt templates takes into account the features of the text types and the distribution patterns of the annotation information. For example, for research and development texts, the generated prompt template may include prompts such as "Please identify the core technical features in the text", "Please extract technological innovation points"; for market texts, the template may include prompts such as "Please analyze the market positioning", "Please extract competitive advantages". These templates are stored in the prompt template library, and a mapping relationship is established with corresponding types of business texts, forming a dynamically updatable template system.

S302, extracting features from the business text data by using the prompt template to obtain initial feature data.

After acquiring the corresponding prompt template, it is necessary to perform feature extraction on the enterprise business text data to obtain initial feature data. The initial feature data refers to structured information extracted from the original business text, which will serve as basic data for constructing the enterprise profile. The reason why feature extraction is needed is that the original business text data is usually unstructured natural language text, which needs to be converted into a structured data format that can be processed by a computer.

In this embodiment, the prompt template includes feature extraction rules, and the feature extraction rules mainly comprise text classification rules and entity recognition rules. The text classification rules are used for determining category attributes of a text, such as classifying a patent document into a research and development class, an application class, etc.; the entity recognition rules are used for recognizing and extracting specific types of entity information from the text, such as company names, technical terms, time and location, etc.

The specific feature extraction process is as follows: First, the system classifies the business text data according to the text classification rules to obtain classification features. For example, for a patent document of an enterprise, the system classifies it into a classification feature of "Artificial Intelligence - Image Recognition - Application Class" by analyzing information such as the technical field description and application scenario in the document. This classification feature can reflect the layout of the enterprise in different technical fields.

Next, the system performs entity recognition on the business text data using the entity recognition rules to obtain entity features. For instance, specific algorithm names, technical parameters, application scenarios, and other entity information are recognized from the patent document. These entity features can describe the technical capabilities and innovation focus of the enterprise in detail.

In order to facilitate subsequent processing, the extracted features need to be vectorized. The system first vectorizes the classification features to obtain classification feature vectors. For example, a classification label such as "Artificial Intelligence - Image Recognition - Application Class" is converted into a multi-dimensional numerical vector. Similarly, the system also vectorizes the entity features to obtain entity feature vectors. During the vectorization process, the system uses a pre-trained word embedding model to convert the text features into numerical vectors of a fixed dimension, which can provide computable mathematical representations while preserving the original semantic information.

Finally, the system concatenates the classification feature vectors and the entity feature vectors to obtain complete initial feature data. The concatenation operation integrates feature information of different dimensions into a unified feature space, forming a comprehensive description of the enterprise business text. For example, for an image recognition patent document of a certain technology company, the initial feature data obtained after feature extraction includes both a vector representation of the technical classification information and vector representations of entity information such as specific algorithms and application scenarios. These features together constitute a digital representation of the patent document.

Based on the above embodiment, as an optional implementation, in S302, the extracting features from the business text data by using the prompt template to obtain initial feature data specifically comprises S21-S25:

S21, acquiring feature extraction rules in the prompt template, wherein the feature extraction rules comprise text classification rules and entity recognition rules.

The feature extraction rules mainly include two important components: text classification rules and entity recognition rules. The text classification rules are used for determining category attributes of a text, while the entity recognition rules are used for recognizing specific entity information in the text. This dual-rule system can analyze the text comprehensively from both macro and micro levels.

S22, classifying the business text data according to the text classification rules to obtain classification features.

S23, performing entity recognition on the business text data according to the entity recognition rules to obtain entity features.

S24, vectorizing the classification features to obtain classification feature vectors, and vectorizing the entity features to obtain entity feature vectors.

After acquiring the feature extraction rules, the system first classifies the business text data by applying the text classification rules. The classification processing adopts a hierarchical classification strategy, i.e., first performing coarse-grained classification and then performing fine-grained classification. For example, for a technical document, the system first classifies it as a "technical document", then further subdivides it into a "research and development class" or "application class", and finally may specifically classify it into a fine category such as "Deep Learning Algorithm - Computer Vision - Object Detection". The system uses a pre-trained classification model during the classification process. This model is trained on large-scale annotated data and can accurately identify the category features of the text. Through this classification processing, the system obtains classification features reflecting the theme and attributes of the text.

Next, the system performs entity recognition on the business text data using the entity recognition rules. The entity recognition process adopts a method combining a deep learning model with rule constraints, which can accurately recognize key entity information in the text. For example, when processing an AI technology patent document, the system can recognize specific entities such as algorithm names (e.g., "YOLO", "ResNet"), performance indicators (e.g., "accuracy 99.5%"), and application scenarios (e.g., "intelligent manufacturing quality inspection"). These entity information items constitute entity features, which describe the specific technical content and key information points in the text in detail.

In order for the extracted features to be efficiently processed by a computer, the classification features and entity features need to be vectorized. The vectorization process uses a pre-trained language model, such as BERT or GPT, to convert text features into numerical vectors of a fixed dimension. For the classification features, the system uses a multi-label encoding method to convert the hierarchical classification information into a representation in a high-dimensional vector space. For example, a classification feature such as "Deep Learning Algorithm - Computer Vision - Object Detection" may be converted into a 300-dimensional vector. For the entity features, the system uses an entity embedding model to encode the recognized entities and their attribute information into numerical vectors. In this way, each entity feature is converted into a vector representation with semantic information.

S25, concatenating the classification feature vectors and the entity feature vectors to obtain the initial feature data.

Finally, the system needs to concatenate the classification feature vectors and the entity feature vectors to obtain complete initial feature data. The concatenation process considers the importance weights of the two types of features and adopts a weighted concatenation method. For example, if the classification feature vector is 300-dimensional and the entity feature vector is 500-dimensional, a concatenated feature vector of 800 dimensions may be obtained, wherein the weights of different dimensions are dynamically adjusted according to the importance of the features.

S303, inputting the initial feature data into a preset model to generate an initial enterprise profile of the enterprise, and modifying the preset model by using the initial enterprise profile to obtain a target model.

After obtaining the initial feature data, it is necessary to generate the initial enterprise profile of the enterprise through the preset model. The preset model is a pre-trained deep learning model used to convert the feature data of the enterprise into a structured enterprise profile representation. The reason for using the preset model is that the business features of an enterprise are often multi-dimensional and multi-level, requiring a powerful model to understand and integrate these complex feature information items. The initial enterprise profile is an enterprise feature description generated by a model for a first time, and comprises a preliminary depiction of the enterprise in terms of multiple dimensions such as technical capability, business orientation, and market position.

In this embodiment, the training process of the preset model is completed on a large-scale annotated sample data set. The annotated sample data set contains feature data of a large number of known enterprises and corresponding profile annotations. These data are divided into a training sample set and a validation sample set according to a preset ratio of 8:2. The system first constructs an initial preset model based on the training sample set, and then inputs the validation sample set into the model for validation to obtain a validation result. The validation result includes performance indicators such as accuracy and recall rate of the model. If the validation result fails to meet a preset condition (e.g., accuracy is lower than 90%), the system will optimize the initial preset model by adjusting model parameters, optimizing network structures, etc., until the validation result meets the requirement, ultimately obtaining a preset model with good performance.

After inputting the initial feature data into the preset model, the model generates the initial enterprise profile of the enterprise. For example, for an enterprise focusing on computer vision technology, the initial enterprise profile may include feature descriptions such as "Core Technology Field: Image Recognition", "Technology Maturity: High", "Market Application Fields: Security Monitoring, Industrial Quality Inspection". However, since the preset model is trained based on general data, it may not be fully adaptable to the unique features of a specific enterprise. Therefore, it is necessary to modify the preset model by using the initial enterprise profile to improve the model's understanding of the enterprise features.

The modification process first acquires feature parameters in the initial enterprise profile as training data. These parameters reflect the specific feature information of the enterprise. The system iteratively adjusts model parameters of the preset model based on the training data, generating a set of candidate model parameters in each iteration. In order to evaluate the effect of parameter adjustment, the system calculates a performance evaluation value for each of the plurality of sets of candidate model parameters. The performance evaluation value is calculated using a comprehensive evaluation indicator (e.g., classification accuracy, feature extraction precision), reflecting the fitting degree of the model to the enterprise features. The system selects a set of candidate model parameters with a maximum performance evaluation value as target parameters, and updates the model parameters of the preset model to the target parameters, ultimately obtaining a more adaptive target model.

Based on the above embodiment, as an optional implementation, in S303, before the inputting the initial feature data into a preset model to generate an initial enterprise profile of the enterprise, the method specifically further comprises S31-S34:

S31, acquiring an annotated sample data set, and dividing the annotated sample data set into a training sample set and a validation sample set according to a preset ratio.

In order to construct a high-performance preset model, model training and optimization need to be performed based on large-scale annotated sample data. First, the annotated sample data set is acquired, which contains feature data of a large number of known enterprises and corresponding enterprise profile annotations. The sources of the annotated sample data include an existing enterprise profile case base, manually annotated enterprise data, etc. To ensure the generalization ability of the model, the system divides the annotated sample data set into a training sample set and a validation sample set according to a preset ratio of 8:2. This division ratio is an optimal ratio verified by a large number of experiments, ensuring both sufficiency of training data and effectiveness of validation.

S32, constructing an initial preset model based on the training sample set.

The process of constructing the initial preset model based on the training sample set adopts a deep neural network architecture. Specifically, the initial preset model is a multi-layer neural network structure, comprising from bottom to top: a feature input layer, a feature extraction layer, a feature fusion layer, a profile generation layer, and an output layer. The feature input layer is responsible for receiving the initial feature data, adopting a fully connected network structure, with an input dimension matching the feature vector dimension. The feature extraction layer is composed of a plurality of convolutional neural network blocks, each block comprising a convolutional layer, a batch normalization layer, and an activation function layer, for extracting local and global information of features. The feature fusion layer adopts a combination of an attention mechanism and residual connections, capable of effectively fusing feature information of different levels. The profile generation layer uses a multi-head self-attention mechanism to capture complex correlations among features. The output layer maps features to a standardized enterprise profile representation through a softmax function.

The training process of the model adopts an iterative optimization strategy. First, a loss function is defined, including a classification loss and a feature reconstruction loss. The classification loss uses a cross-entropy loss function to measure the difference between predicted profile and true annotation; the feature reconstruction loss uses a mean squared error loss function to ensure that the model can retain key information of the original features. The optimizer uses the Adam optimizer, the learning rate adopts a cosine annealing strategy, and the initial learning rate is set to 0.001. A batch training method is used during training, with 64 samples per batch, and a total of 100 epochs to be trained. To prevent overfitting, techniques such as dropout and L2 regularization are also introduced.

S33, inputting the validation sample set into the initial preset model for validation to obtain a validation result.

S34, optimizing the initial preset model according to the validation result until the validation result meets a preset condition, to obtain the preset model.

When inputting the validation sample set into the initial preset model for validation, the system calculates a plurality of validation indicators. These indicators include model accuracy (matching degree between predicted profile and true profile), recall rate (ability of the model to capture key features), F1 score (harmonic mean of accuracy and recall rate), and feature fidelity (degree to which the model retains original feature information). For example, for a validation sample of a technology enterprise, the system validates whether the model can accurately identify key features such as its technical field and innovation capability.

The process of optimizing the initial preset model according to the validation result is iterative. If the validation result fails to meet the preset condition (e.g., accuracy lower than 90%, F1 score lower than 0.85), the system takes a series of optimization measures. First is network structure optimization, including adjusting the number of network layers, changing convolutional kernel sizes, modifying attention mechanism parameters, etc. Second is hyperparameter optimization, using methods such as grid search or Bayesian optimization to find optimal learning rates, batch sizes, regularization parameters, etc. Finally, ensemble learning optimization is performed to improve model performance through model ensemble methods.

Based on the above embodiment, as an optional implementation, in S303, the modifying the preset model by using the initial enterprise profile to obtain a target model specifically comprises S41-S44:

S41, acquiring feature parameters in the initial enterprise profile as training data.

In order to make the preset model better adapt to the features of a specific enterprise, it is necessary to use the information in the initial enterprise profile to perform targeted modification on the model. Taking a certain technology company focusing on autonomous driving technology as an example, the initial enterprise profile of the company contains 200-dimensional feature parameters, which reflect quantitative indicators of the enterprise in multiple dimensions such as technological innovation, market performance, and development potential. For example, the technological innovation dimension includes parameters such as "Algorithm Innovation Capability: 0.95", "Patent Quality Index: 0.88", and the market performance dimension includes parameters such as "Market Share Growth Rate: 0.75", "Customer Satisfaction: 0.92". These feature parameters serve as training data to guide the parameter adjustment of the preset model.

S42, iteratively adjusting model parameters of the preset model based on the training data to obtain a plurality of sets of candidate model parameters.

The iterative adjustment of model parameters adopts a method combining gradient descent and genetic algorithms. First, the system uses a stochastic gradient descent method to fine-tune parameters of different layers of the preset model, while introducing genetic algorithms to explore a larger parameter space. In each iteration, the system generates a plurality of sets of candidate model parameters. Taking the autonomous driving enterprise as an example, the system may try different weight configurations in the network layers processing technology-related features in response to its high technological innovation features. For example, a parameter configuration enhancing the weight of technological innovation (weight coefficient 1.2), a parameter configuration balancing technology and market (weight coefficient 1.0), etc., may be generated, forming 10 different candidate model parameter sets.

S43, calculating a performance evaluation value for each of the plurality of sets of candidate model parameters, and taking a set of candidate model parameters with a maximum performance evaluation value as target parameters.

S44, updating the model parameters of the preset model to the target parameters to obtain the target model.

For each of the plurality of sets of candidate model parameters, the system calculates the performance evaluation value by using a comprehensive evaluation indicator. The evaluation indicator comprises model prediction accuracy (accounting for 40%), feature fidelity (accounting for 30%), and generalization capability (accounting for 30%). Taking a certain candidate parameter set as an example, when processing the data of this autonomous driving enterprise, if the prediction accuracy reaches 96%, feature fidelity reaches 94%, and generalization capability score is 0.91, a comprehensive performance evaluation value would be 0.94. By comparing the performance evaluation values of all the plurality of sets of candidate parameters, the system selects a set of parameters with a highest evaluation value as the target parameters.

Finally, the system updates the model parameters of the preset model to the target parameters to complete the customized modification of the model. This update process adopts a smooth transition strategy, i.e., introducing an attenuation factor (e.g., 0.8) to retain part of the generality of the original model, while incorporating the new target parameters to enhance the sensitivity of the model to specific enterprise features. After such modification, the obtained target model exhibits better performance when processing profile generation tasks for this autonomous driving enterprise and similar enterprises.

S304, retrieving a plurality of external business information items of the enterprise, calculating a correlation value between each of the plurality of external business information items and the initial enterprise profile, and inputting external business information items having correlation values greater than a preset threshold into the target model to obtain supplementary features.

Since the internal business text data of the enterprise may have incomplete information or may not be updated in a timely manner, the initial enterprise profile generated solely based on internal data may not fully reflect the actual situation of the enterprise. Therefore, it is necessary to supplement and improve the enterprise profile by retrieving external business information of the enterprise. External business information includes, but is not limited to, industry analysis reports, news information, market research reports, competitor analysis, expert comments, and other public information.

In this embodiment, the system first retrieves external business information related to the enterprise from public data sources. The retrieving comprises simultaneously acquiring information from a plurality of data sources based on a multi-source retrieval strategy. For example, for an enterprise focusing on artificial intelligence technology, the system retrieves information such as technical discussions of the enterprise on professional technology forums, reports from industry media, and analysis reports from third-party consulting agencies. To ensure the timeliness of the retrieval results, the system preferentially acquires information from the last year and performs preliminary screening based on the authority of the information source.

After acquiring the external business information, it is necessary to calculate a correlation value between the information and the initial enterprise profile to screen out the most valuable supplementary information. The correlation value is a numerical indicator measuring a degree of matching between external information and existing features of the enterprise, with a value range from 0 to 1, wherein a larger value indicates a higher correlation. The specific calculation method is to convert the external business information and the initial enterprise profile into feature vectors, and then calculate a degree of similarity between the vectors by using a cosine similarity algorithm. For example, if an industry report analyzes in detail the technological innovation of the enterprise in the field of computer vision, and the initial enterprise profile also contains related technical features, then the correlation value of this report will likely be high.

The system compares the correlation value with a preset threshold to screen out highly relevant external business information. The preset threshold is typically set to 0.7 or higher, a value determined through a large amount of experimental data, which can effectively filter out information with weak relevance. For external business information items having correlation values greater than the preset threshold, the system performs text preprocessing on them, including operations such as noise removal and format unification, to obtain preprocessed texts.

The preprocessed texts are then input into the feature extraction layer of the target model. The feature extraction layer is a network layer in the target model specifically responsible for extracting text features, which can extract key semantic features from the text and generate feature vectors. For example, vector representations of key information such as the enterprise's technical advantages, market positioning, and development strategies are extracted from an analysis report.

In order to integrate features from multiple external information sources, the system performs feature fusion on the extracted feature vectors based on a preset fusion rule. The fusion rule includes methods such as weighted averaging and an attention mechanism, used to organically combine feature information from different sources to obtain fused features. Finally, the fused features are input into the feature mapping layer of the target model, and through mapping and transformation by a deep neural network, the final supplementary features are obtained.

Based on the above embodiment, as an optional implementation, in S304, the inputting external business information items having correlation values greater than a preset threshold into the target model to obtain supplementary features specifically comprises S51-S54:

S51, performing text preprocessing on the external business information items having correlation values greater than the preset threshold to obtain preprocessed texts.

First, text preprocessing is performed on these highly relevant external business information items. The preprocessing process includes steps such as text cleaning (removing special characters, unifying formats), word segmentation (using a specialized dictionary for technical term recognition), and stop word removal. For example, for a technical blog of the AI chip enterprise, the system identifies key technical indicators such as "7nm process", "computing power increased by 300%", and "power consumption reduced by 50%", and converts the text into a standardized format. This preprocessing process ensures the accuracy of subsequent feature extraction.

S52, extracting a feature extraction layer from the target model, and inputting the preprocessed texts into the feature extraction layer to obtain feature vectors.

Next, the feature extraction layer is extracted from the target model. The feature extraction layer of the target model is a sub-network containing multiple convolutional neural network layers, specifically used for extracting deep features from text. By inputting the preprocessed texts into the feature extraction layer, the system generates corresponding feature vectors. Taking the technical blog as an example, the feature extraction layer can capture features in multiple dimensions such as process level, performance improvement, and energy consumption optimization, and encode them into a 500-dimensional feature vector. Each dimension in this feature vector corresponds to specific semantic information.

S53, performing feature fusion on the feature vectors based on a preset fusion rule to obtain fused features.

S54, inputting the fused features into a feature mapping layer of the target model to obtain the supplementary features.

Then, feature fusion is performed on the feature vectors based on the preset fusion rule. The fusion rule adopts a combination of an attention mechanism and weighted averaging, taking into account the credibility and importance of information from different sources. For example, for features from an official technical blog, the system assigns a higher weight (e.g., 0.8); for features from a third-party analysis report, a relatively lower weight is assigned (e.g., 0.6). Through this weighted fusion method, the system integrates a plurality of feature vectors into one 300-dimensional fused feature. This fusion process ensures that important information is fully retained while redundant and noisy information is filtered out.

Finally, the fused features are input into the feature mapping layer of the target model to generate the final supplementary features. The feature mapping layer is a fully connected neural network responsible for mapping the fused features to the same feature space as the enterprise profile. For the AI chip enterprise, the feature mapping layer converts the 300-dimensional fused features into 200-dimensional supplementary features. These supplementary features correspond to the feature dimensions of the enterprise profile and include quantitative indicators in multiple aspects such as technological innovation capability, market competitiveness, and development potential.

S305, inputting the initial enterprise profile and the supplementary features into the target model to generate enterprise profile tags for the enterprise.

After obtaining the initial enterprise profile and the supplementary features, it is necessary to integrate this information and generate final enterprise profile tags. Enterprise profile tags are highly summarized and standardized expressions of enterprise features, including tagged descriptions in multiple dimensions such as technical capability, business orientation, and development stage. The purpose of generating standardized enterprise profile tags is to facilitate rapid identification, precise matching, and efficient application of enterprise features, for example, playing an important role in scenarios such as business recommendation, risk assessment, and partner selection.

In this embodiment, it is first necessary to perform feature merging on the initial enterprise profile and the supplementary features. The initial enterprise profile comprises basic features extracted from internal data of the enterprise, while the supplementary features comprise extended features acquired from external information. The two types of features have distinct characteristics and complement each other. The feature merging process uses a feature fusion algorithm, which considers the importance weights of different features and integrates the two types of features organically through a weighted combination method. For example, for an artificial intelligence enterprise, its initial enterprise profile may focus on the description of technical capabilities, while the supplementary features may contain more market feedback and industry evaluations. Through feature merging, a complete feature representation covering both technical and market dimensions can be obtained.

To ensure feature comparability and computational stability, the system normalizes the merged features to obtain standardized features. Normalization processing includes unification of numerical ranges, elimination of dimensions, handling of outliers, etc., so that features of different dimensions are mapped to the same numerical interval, facilitating subsequent model processing. For example, all numerical features are uniformly mapped to the interval [0,1] to ensure fair comparison and calculation of features of different dimensions.

The standardized features are then input into the classification layer of the target model. The classification layer is a specially trained neural network layer capable of mapping the input features to a set of predicted probability values. These predicted probability values reflect the matching degree of the enterprise in different tag categories. For example, in the dimension of technological innovation capability, the model may output a probability of 0.85 for "leading type", 0.12 for "following type", and 0.03 for "starting type", indicating that the enterprise is most likely a technologically leading enterprise.

Finally, the system maps the predicted probability values to specific enterprise profile tags according to a preset tag mapping rule. The tag mapping rule is a set of predefined transformation rules for converting probability values into standardized tag expressions. These rules consider not only the maximum probability value of a single dimension, but also the logical relationships among multiple dimensions to ensure that the generated tag combination is practically meaningful. For example, a certain technology enterprise may ultimately be labeled as a multi-dimensional tag combination such as "Technological Innovation Type - Market Leading Level - Rapid Growth Stage - High R&D Investment - Series B Financing Stage".

Taking an AI chip enterprise as an example, by integrating its technology patent data (initial enterprise profile) and the latest market feedback information (supplementary features), the system successfully generates precise profile tags such as "Hard Technology Innovation Enterprise - AI Chip Field Leader - Commercialization Stage - Domestic Substitution Direction". These tags not only accurately reflect the core features of the enterprise, but also reflect the positioning and development trend of the enterprise in the industry.

Based on the above embodiment, as an optional implementation, in S305, the inputting the initial enterprise profile and the supplementary features into the target model to generate enterprise profile tags for the enterprise specifically comprises S61-S64:

S61, performing feature merging on the initial enterprise profile and the supplementary features to obtain merged features.

In order to obtain accurate and easily understandable enterprise profile tags, it is necessary to effectively integrate and process the initial enterprise profile and the supplementary features. Taking a certain high-tech enterprise focusing on quantum computing as an example, its initial enterprise profile is a 200-dimensional feature vector containing quantitative indicators such as basic technical capability, innovation level, and market position; the supplementary features are a 200-dimensional vector reflecting the latest technological breakthroughs, market performance, and other dynamic information of the enterprise. The system performs feature merging by using a combination of feature concatenation and weighted superposition to obtain a 400-dimensional merged feature. During the merging process, for overlapping feature dimensions (e.g., technological innovation capability), the system assigns different weights according to timeliness. For example, a weight of 0.4 is assigned to historical data in the initial enterprise profile, and a weight of 0.6 is assigned to the latest data in the supplementary features, ensuring that the merged features retain both historical stability and reflect the latest changes.

S62, normalizing the merged features to obtain standardized features.

In order to eliminate dimensional differences among different feature dimensions, the system normalizes the merged features. Normalization uses an improved Z-score standardization method, which not only considers the mean and variance of the features, but also introduces an industry background factor to adjust the standardization process. For example, for the technical indicators of the quantum computing enterprise, the system adjusts the standardization parameters according to the overall development level of the quantum computing field. Specifically, if the original value of a certain technical indicator is 0.85, the industry mean is 0.6, the standard deviation is 0.15, and the industry background factor is 1.2, the standardized value is [(0.85-0.6)/(0.15*1.2)]. The standardized features processed in this way can more accurately reflect the relative position of the enterprise in the industry.

S63, inputting the standardized features into a classification layer of the target model to obtain predicted probability values.

When inputting the standardized features into the classification layer of the target model, the system adopts a multi-layer softmax classifier structure, with each layer corresponding to profile tags of different dimensions. The classification layer processes the standardized features through a deep neural network and outputs predicted probability values for multiple dimensions. Taking the quantum computing enterprise as an example, the classification layer outputs probability distributions for multiple dimensions such as technological innovation type (e.g., probability of 0.92 for "original technology type", 0.05 for "technology application type"), development stage (e.g., probability of 0.88 for "rapid growth stage", 0.10 for "mature stage"), and core competitiveness (e.g., probability of 0.95 for "technology leading type", 0.03 for "market driven type").

S64, mapping the predicted probability values to the enterprise profile tags corresponding to the enterprise according to a preset tag mapping rule.

Finally, the system maps these predicted probability values to specific enterprise profile tags according to the preset tag mapping rule. The tag mapping rule considers not only the maximum probability value of a single dimension, but also the logical associations among multiple dimensions. For example, when the technological innovation type is "original technology type" (probability 0.92) and the core competitiveness is "technology leading type" (probability 0.95), the system labels the enterprise as a "technological innovation leading enterprise"; when these tags are combined with the development stage of the enterprise being "rapid growth stage" (probability 0.88), the final generated profile tag combination is "Rapidly Growing Technological Innovation Leading Enterprise".

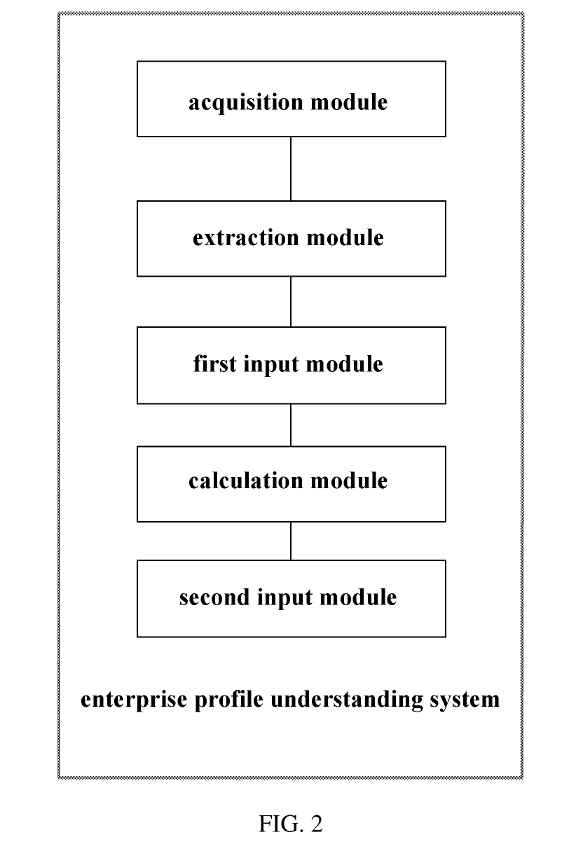

Based on the above method, the present application further discloses a system for understanding an enterprise profile. As shown in FIG. 2, FIG. 2 is a schematic structural diagram of a system for understanding an enterprise profile provided by an embodiment of the present application. The system comprises: an acquisition module, an extraction module, a first input module, a calculation module, and a second input module.

The acquisition module is configured to acquire enterprise business text data, and select, from a prompt template library, a prompt template corresponding to a type of the business text data; the extraction module is configured to extract features from the business text data by using the prompt template to obtain initial feature data; the first input module is configured to input the initial feature data into a preset model to generate an initial enterprise profile of the enterprise, and modify the preset model by using the initial enterprise profile to obtain a target model; the calculation module is configured to retrieve a plurality of external business information items of the enterprise, calculate a correlation value between each of the plurality of external business information items and the initial enterprise profile, and input external business information items having correlation values greater than a preset threshold into the target model to obtain supplementary features; and the second input module is configured to input the initial enterprise profile and the supplementary features into the target model to generate enterprise profile tags for the enterprise.

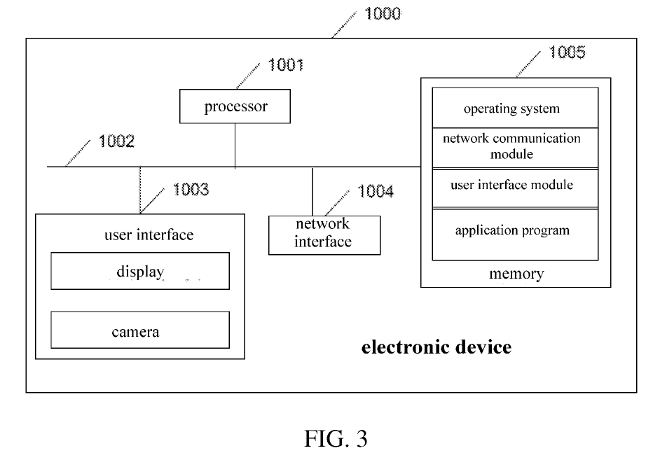

FIG. 3 is a schematic structural diagram of an electronic device provided by an embodiment of the present application. As shown in FIG. 3, the electronic device 1000 may include: at least one processor 1001, at least one network interface 1004, a user interface 1003, a memory 1005, and at least one communication bus 1002.

As shown in FIG. 3, the memory 1005, as a computer storage medium, may include an operating system, a network communication module, a user interface module, and an application program of a method for understanding an enterprise profile.

In the electronic device 1000 shown in FIG. 3, the user interface 1003 is mainly used for providing an input interface for a user to acquire data input by the user; and the processor 1001 may be used for calling the application program of a method for understanding an enterprise profile stored in the memory 1005, which, when executed by one or more processors, causes the electronic device to execute the method described in one or more of the above embodiments.

An electronic device-readable storage medium with instructions stored thereon, which, when executed by one or more processors, cause an electronic device to execute the method described in one or more of the above embodiments.

The above descriptions are only exemplary embodiments of the present disclosure and cannot be used to limit the scope of the present disclosure. That is, any equivalent changes and modifications made according to the teachings of the present disclosure shall still fall within the scope covered by the present disclosure. Those skilled in the art, after considering the specification and practicing the disclosure herein, will readily conceive of other embodiments of the present disclosure. The present application is intended to cover any variations, uses, or adaptive changes of the present disclosure, which follow the general principles of the present disclosure and include common knowledge or customary technical means in the art that are not disclosed in the present disclosure. The specification and embodiments are to be regarded as exemplary only, and the scope and spirit of the present disclosure are defined by the claims.

1. A method for understanding an enterprise profile, comprising:
acquiring enterprise business text data, and selecting, from a prompt template library, a prompt template corresponding to a type of the enterprise business text data;
extracting features from the enterprise business text data by using the prompt template to obtain initial feature data;
inputting the initial feature data into a preset model to generate an initial enterprise profile of an enterprise, and modifying the preset model by using the initial enterprise profile to obtain a target model;
retrieving a plurality of external business information items of the enterprise, calculating a correlation value between each of the plurality of external business information items and the initial enterprise profile, and inputting external business information items having correlation values greater than a preset threshold into the target model to obtain supplementary features; and
inputting the initial enterprise profile and the supplementary features into the target model to generate enterprise profile tags for the enterprise.

2. The method for understanding an enterprise profile according to claim 1, wherein the enterprise business text data comprises patent documents, bidding information, marketing activity data, business registration information, legal information, and fiscal and taxation information of the enterprise; and the acquiring the enterprise business text data, and selecting, from the prompt template library, the prompt template corresponding to the type of the business text data comprises:
acquiring the enterprise business text data, and analyzing format features, keyword distribution, and section structure information of the enterprise business text data to determine a text type; and
after identifying the text type of the enterprise business text data, selecting, from the prompt template library, the prompt template corresponding to the type of the business text data; wherein the prompt template library stores prompt templates respectively corresponding to different types of business text data, and each of the prompt templates comprises processing rules and extraction strategies for a specific type of business text.

3. The method for understanding an enterprise profile according to claim 1, wherein, before the selecting, from the prompt template library, the prompt template corresponding to the type of the business text data, the method further comprises:
acquiring a business text data set of the enterprise, and classifying the business text data set to obtain a plurality of data sets;
selecting, from a preset keyword library, keywords corresponding to text features of each of the plurality of data sets;
annotating each of the plurality of data sets according to the keywords to obtain multiple types of business text data; and
generating a prompt template corresponding to each type of business text data, storing the prompt templates in the prompt template library, and establishing a mapping relationship between each type of business text data and the corresponding prompt template.

4. The method for understanding an enterprise profile according to claim 3, wherein the acquiring the business text data set of the enterprise, and classifying the business text data set to obtain the plurality of data sets comprises:
acquiring the business text data set of the enterprise, and performing a preliminary classification on the business text data set based on format features and content features of the business text data set; wherein the format features comprise document structure and section structure, and the content features comprise technical terms and industry terms; and
optimizing and adjusting a result of the preliminary classification by using a pre-trained text classification model to obtain the plurality of data sets.

5. The method for understanding an enterprise profile according to claim 3, wherein the selecting, from the preset keyword library, the keywords corresponding to the text features of each of the plurality of data sets comprises:
classifying and organizing the preset keyword library according to different business fields and text types, wherein the preset keyword library comprises a dictionary of technical terms and key expressions in the business fields; and
selecting, from the preset keyword library, the keywords corresponding to the text features of each of the plurality of data sets.

6. The method for understanding an enterprise profile according to claim 3, wherein the annotating each of the plurality of data sets according to the keywords to obtain the multiple types of business text data comprises:
automatically annotating texts in each of the plurality of data sets by using the keywords to obtain the multiple types of business text data, wherein the automatically annotating comprises: keyword matching, semantic analyzing, and context understanding.

7. The method for understanding an enterprise profile according to claim 1, wherein the extracting the features from the enterprise business text data by using the prompt template to obtain the initial feature data comprises:
acquiring feature extraction rules in the prompt template, wherein the feature extraction rules comprise text classification rules and entity recognition rules;
classifying the enterprise business text data according to the text classification rules to obtain classification features;
performing entity recognition on the enterprise business text data according to the entity recognition rules to obtain entity features;
vectorizing the classification features to obtain classification feature vectors, and vectorizing the entity features to obtain entity feature vectors; and
concatenating the classification feature vectors and the entity feature vectors to obtain the initial feature data.

8. The method for understanding an enterprise profile according to claim 7, wherein the classifying the enterprise business text data according to the text classification rules to obtain the classification features comprises:
classifying the enterprise business text data by applying the text classification rules to obtain the classification features, wherein the text classification rules are used for determining category attributes of a text, and the classifying comprises a hierarchical classification strategy, and the hierarchical classification strategy comprises first performing coarse-grained classification and then performing fine-grained classification.

9. The method for understanding an enterprise profile according to claim 7, wherein the performing the entity recognition on the enterprise business text data according to the entity recognition rules to obtain the entity features comprises:
recognizing key entity information in the enterprise business text data according to the entity recognition rules by using a deep learning model combined with rule constraints, wherein the entity recognition rules are used for recognizing and extracting specific types of entity information from the enterprise business text data.

10. The method for understanding an enterprise profile according to claim 1, wherein before the inputting the initial feature data into the preset model to generate the initial enterprise profile of the enterprise, the method further comprises:
acquiring an annotated sample data set, and dividing the annotated sample data set into a training sample set and a validation sample set according to a preset ratio;
constructing an initial preset model based on the training sample set;
inputting the validation sample set into the initial preset model for validation to obtain a validation result; and
optimizing the initial preset model according to the validation result until the validation result meets a preset condition, to obtain the preset model.

11. The method for understanding an enterprise profile according to claim 1, wherein the modifying the preset model by using the initial enterprise profile to obtain the target model comprises:
acquiring feature parameters in the initial enterprise profile as training data;
iteratively adjusting model parameters of the preset model based on the training data to obtain a plurality of sets of candidate model parameters;
calculating a performance evaluation value for each of the plurality of sets of candidate model parameters, and taking a set of candidate model parameters with a maximum performance evaluation value as target parameters; and
updating the model parameters of the preset model to the target parameters to obtain the target model.

12. The method for understanding an enterprise profile according to claim 1, wherein the initial enterprise profile is an enterprise feature description generated by a model for a first time, and the enterprise feature description comprises a preliminary depiction of the enterprise in terms of technical capability, business orientation, and market position.

13. The method for understanding an enterprise profile according to claim 11, wherein the calculating the performance evaluation value for each of the plurality of sets of candidate model parameters, and taking the set of candidate model parameters with the maximum performance evaluation value as target parameters comprises:
for each of the plurality of sets of candidate model parameters, calculating the performance evaluation value by using a comprehensive evaluation indicator, wherein the comprehensive evaluation indicator comprises model prediction accuracy, feature fidelity, and generalization capability; and
comparing the performance evaluation values of all the plurality of sets of candidate model parameters, and selecting a set of parameters with a highest evaluation value as the target parameters.

14. The method for understanding an enterprise profile according to claim 1, wherein the inputting the external business information items having the correlation values greater than the preset threshold into the target model to obtain the supplementary features comprises:
performing text preprocessing on the external business information items having the correlation values greater than the preset threshold to obtain preprocessed texts;
extracting a feature extraction layer from the target model, and inputting the preprocessed texts into the feature extraction layer to obtain feature vectors;
performing feature fusion on the feature vectors based on a preset fusion rule to obtain fused features; and
inputting the fused features into a feature mapping layer of the target model to obtain the supplementary features.

15. The method for understanding an enterprise profile according to claim 1, wherein the correlation value is a numerical indicator measuring a degree of matching between external information and existing features of the enterprise, with a value range from 0 to 1, and the retrieving the plurality of external business information items of the enterprise, calculating the correlation value between each of the plurality of external business information items and the initial enterprise profile comprises:
retrieving external business information related to the enterprise from public data sources, wherein the retrieving comprises simultaneously acquiring information from a plurality of data sources based on a multi-source retrieval strategy; and
converting the external business information and the initial enterprise profile into feature vectors, and calculating a degree of similarity between the feature vectors by using a cosine similarity algorithm to obtain the correlation value between each of the plurality of external business information items and the initial enterprise profile.

16. The method for understanding an enterprise profile according to claim 14, wherein the performing the feature fusion on the feature vectors based on the preset fusion rule to obtain the fused features comprises:
performing the feature fusion on the feature vectors based on the preset fusion rule, wherein the fusion rule adopts a combination of an attention mechanism and weighted averaging; wherein a feature from an official technical blog is assigned a higher weight than a feature from a third-party analysis report; and
integrating a plurality of feature vectors into one fused feature.

17. The method for understanding an enterprise profile according to claim 1, wherein the inputting the initial enterprise profile and the supplementary features into the target model to generate the enterprise profile tags for the enterprise comprises:
performing feature merging on the initial enterprise profile and the supplementary features to obtain merged features;
normalizing the merged features to obtain standardized features;
inputting the standardized features into a classification layer of the target model to obtain predicted probability values; and
mapping the predicted probability values to the enterprise profile tags corresponding to the enterprise according to a preset tag mapping rule.

18. The method for understanding an enterprise profile according to claim 17, wherein the initial enterprise profile comprises basic features extracted from internal data of the enterprise, and the supplementary features comprise extended features acquired from external information; and the performing the feature merging on the initial enterprise profile and the supplementary features to obtain the merged features comprises:
performing the feature merging on the initial enterprise profile and the supplementary features by using a combination of feature concatenation and weighted superposition to obtain the merged features.

19. A system for understanding an enterprise profile, comprising: an acquisition module, an extraction module, a first input module, a calculation module, and a second input module; wherein,
the acquisition module is configured to acquire enterprise business text data, and select, from a prompt template library, a prompt template corresponding to a type of the enterprise business text data;
the extraction module is configured to extract features from the enterprise business text data by using the prompt template to obtain initial feature data;
the first input module is configured to input the initial feature data into a preset model to generate an initial enterprise profile of an enterprise, and modify the preset model by using the initial enterprise profile to obtain a target model;
the calculation module is configured to retrieve a plurality of external business information items of the enterprise, calculate a correlation value between each of the plurality of external business information items and the initial enterprise profile, and input external business information items having correlation values greater than a preset threshold into the target model to obtain supplementary features; and
the second input module is configured to input the initial enterprise profile and the supplementary features into the target model to generate enterprise profile tags for the enterprise.

20. A non-transitory computer-readable storage medium with a computer program stored thereon, wherein the computer program is configured to be loaded and executed by a processor to implement the method for understanding an enterprise profile according to claim 1.
